(19) United States
(12) Patent Application Publication
(10) Pub. No.: US 2026/0356597 A1
(43) Pub. Date: Nov. 12, 2026

(54) METHOD FOR CONTROLLING A CONVEYING DEVICE AND CONVEYING FACILITY

(71) Applicant: SIDEL PARTICIPATIONS, Octeville-sur-Mer (FR)

(72) Inventor: Marc KAPP, REICHSTETT (FR)

(21) Appl. No.: 19/139,624

(22) PCT Filed: Dec. 19, 2023
(86) PCT No.: PCT/EP2023/086764

§ 371 Date: Jun. 16, 2025

(30) Foreign Application Priority Data
Dec. 20, 2022 (FR) FR2213936

(51) Int. Cl. B65G 43/02; B65G 45/22

(52) U.S. Cl. CPC B65G 43/02; B65G 45/22; B65G 2203/0275; B65G 2203/0291

(57) ABSTRACT

Provided is a method for controlling a conveying device for conveying items. The conveying device includes a conveyor belt provided with a conveying surface, a drive motor and a control unit. The method can include: measuring a roughness coefficient of the conveying surface; transmitting the measurement to the control unit; generating instructions for regulating the speed of the conveyor belt in the form of a speed setpoint via the control unit according to the measured roughness coefficient; and transmitting the instructions to the conveying device. Also described is a conveying facility that implements the method.

The present invention relates to the field of methods and devices for conveying of articles. Its subject is a method for controlling a conveying device and the conveying facility which implements this method.

In the field of the present invention the articles, such as containers or cardboard boxes, are displaced by means of conveyor belts on which they are supported.

The article is preferably a container, of the bottle or vial type. Non-exhaustively, a container of this type is designed to contain a fluid, liquid, powders or granules, in particular of the foodstuffs or cosmetics type.

In a known manner, within an industrial line, and in particular within a packaging facility, the containers can be subjected to a plurality of different successive treatments, such as the manufacture of the container, for example during an operation of plastic injection or stretching-blowing in the case of a bottle made of plastic material, followed by filling then closure by a stopper and labelling. After the different processing operations, the containers are packaged in batches. Thus, each batch comprises a plurality of containers assembled in groups, for example in accordance with an arrangement in the form of a matrix, generally with a globally parallelepiped form, which is often square or rectangular, according to the columns and rows. Within the packaging line, the articles are displaced in order to be subjected to the different operations of filling, handling, packaging and the like. For this purpose, between an upstream processing station and a downstream processing station, the articles, in particular the containers, are transported by means of conveying devices within a conveying facility. Conveying devices of this type are generally composed of one or a plurality of endless conveyor belts supported by guide means and driven by a drive motor.

The production of finished containers, then of batches of containers, requires a high conveying pace, in order to supply to the different stations in a sustained manner. Thus, each station receives articles to be processed, without a stoppage time in the processing of said articles. In particular when containers are involved, the articles are transported vertically, i.e. they are supported on their base.

In certain areas of the facility, the articles do not necessarily circulate on a linear transport path. The transport path can comprise curves and guide elements. The articles, and in particular the containers, can also pass in succession via different configurations, for example from a so-called bulk configuration to a configuration in lines or in rows, and conversely. This change of configuration can give rise to falling or also blockages.

It is also well known that the friction between the surface in motion of a conveying device and the article to be transported affects considerably the stability of said articles on the conveyor, which gives rise to a high degree of falling of the articles, and reduces considerably the performance of the conveying device.

It is therefore desirable for the conveyor belts of the conveying devices to have a previously determined permissible roughness value, since, in cases when the roughness value is too high or too low, the conveying speed, the path of the articles, in particular the containers, or also the guide elements, can give rise to problems during the conveying, for example falling of the containers. Thus, when the roughness values are too low or too high, the efficiency of the conveying device is directly affected.

In addition, the values of friction between the articles and the surface of the conveyor belt itself depend on multiple parameters, such as the quality of the conveyor belt and the nature of the articles to be transported.

In the field of the invention, it is therefore necessary to control the values of roughness of the conveyor belt in order to guarantee efficient conveying of the articles by a conveying device within the facility for packaging of articles.

It is known to use lubrication devices along the transport device within a conveying facility, in order to be able to correct the roughness of the conveyor belt. The disadvantage of a correction method of this type is that it requires a complicated installation and starting procedure. In addition, this solution is costly, and the lubrication is not always efficient, or it takes time before the coefficient of roughness reaches an appropriate value.

Before the coefficient of roughness reaches this permissible or optimal value, it may happen that the articles, in particular the containers, are not transported reliably, and fall on the conveyor belt, which results in a significant loss of performance of the line.

On the contrary, it may happen that the conveyor belt is lubricated excessively. In this case, the articles to be transported do not benefit from sufficient gripping, and are no longer conveyed at the required speed, but at a far lower speed. Once again, this can then result in a drop in performance of the line.

These different disadvantages also tend to increase the electrical consumption of the systems which drive the conveyors, to increase in the wear of the conveyor belt, and to increase in the general sound level of the conveyors in operation.

The objective of the invention is thus to provide a method for controlling a conveying device, which makes it possible to intervene directly on the efficiency thereof, when the value of the coefficient of roughness diverges from the appropriate value for optimal conveying of the articles.

For this purpose, the invention proposes regulation of the conveying speed of the transport device according to the value of the coefficient of roughness measured. Thus, the conveying of the articles is ensured efficiently, without needing to wait for an improvement in the roughness of the conveyor belt.

For this purpose, the subject of the invention is firstly a method for controlling a conveying device for transporting articles, said conveying device comprising a conveyor belt provided with a transport surface, a drive motor and a control unit.

According to the invention, the method is characterized in that it comprises at least the following steps of:
carrying out a measurement of a coefficient of roughness of the transport surface;
transmission of said measurement to the control unit;
generation of instructions for regulation of the speed of the conveyor belt in the form of a speed instruction by the control unit, according to the coefficient of roughness measured; and
transmission of said instructions to said conveying device.

In some embodiments, the step of generation of instructions comprises an additional sub-step of comparison of the measurement of the coefficient of roughness with a predetermined minimal coefficient of roughness and/or with a predetermined maximal coefficient of roughness, and the control unit generates instructions for regulation of the speed,
if the difference between the measurement of the coefficient of roughness and the value of the minimal coefficient of roughness and/or the value of the maximal coefficient of roughness is greater than a determined threshold.

According to a possible additional characteristic, the control unit generates a speed instruction defined according to a coefficient of proportionality applied to the measurement of the coefficient of roughness.

In some embodiments, the control unit generates instructions in the form of an instruction for reduction of the speed of the conveyor belt, when the measurement of the coefficient of roughness is greater than a predetermined maximal coefficient of roughness.

In some embodiments, the control unit generates instructions in the form of an instruction for increase of the speed of the conveyor belt, when the measurement of the coefficient of roughness is lower than a predetermined minimal coefficient of roughness.

According to a possible additional characteristic, the control method comprises an additional step of lubrication of the transport surface of the conveyor belt by at least one lubrication system, the control unit being connected to said at least one lubrication system, and generating lubrication instructions in the form of a lubrication instruction on the basis of the measurement of the coefficient of roughness.

In some embodiments, the step of generation of lubrication instructions comprises an additional sub-step of comparison of the measurement of the coefficient of roughness with a predetermined minimal coefficient of roughness, and/or with a predetermined maximal coefficient of roughness, and the control unit generates lubrication instructions if the difference between the measurement of the coefficient of roughness and the value of the minimal coefficient of roughness and/or the maximal coefficient of roughness is greater than a determined threshold.

According to a possible additional characteristic, the control method comprises an additional step of cleaning of the transport surface of the conveyor belt by a cleaning system, with the control unit being connected to said cleaning system, and generating cleaning instructions in the form of a cleaning instruction according to the coefficient of roughness measured.

In some embodiments, the step of generation of cleaning instructions comprises an additional sub-step of comparison of the measurement of the coefficient of roughness with a predetermined minimal coefficient of roughness and/or a predetermined maximal coefficient of roughness, and the control unit generates cleaning instructions if the difference between the measurement of the coefficient of roughness and the value of the minimal coefficient of roughness and/or the value of the maximal coefficient of roughness is greater than a determined threshold.

The subject of the invention is also a conveying facility comprising a conveying device which is designed to transport articles, said device comprising a conveyor belt provided with a transport surface, a drive motor and a control unit, and at least one sensor.

The facility is characterized in that the control unit generates instructions for regulation of the speed in the form of a speed instruction of the conveyor belt according to the measurement of a coefficient of roughness by at least one sensor, said control unit comprising a communication channel to transmit said instructions to said conveying device.

Advantageously, the facility implements the method as described above.

According to a possible additional characteristic, the control unit comprises a memory device in which there are recorded predetermined values of the minimal and maximal coefficients of roughness, and a comparison device to compare a coefficient of roughness measured by a sensor with the values of the coefficients of roughness recorded.

In some embodiments, the facility comprises at least one system for lubrication of the transport surface of the conveyor belt, with said at least one lubrication system comprising a source of lubricant and an applicator for said lubricant, and said at least one lubrication system can receive lubrication instructions from the control unit in the form of a lubrication instruction on the basis of the measurement of a coefficient of roughness by a sensor.

According to a possible additional characteristic, the conveying facility comprises a system for cleaning of the transport surface of the conveyor belt, said cleaning system being able to receive instructions from the control unit in the form of a cleaning instruction on the basis of the measurement of a coefficient of roughness by a sensor.

The invention also concerns a computer program product comprising a sequence of instructions which, when the program is executed by a computer, leads the computer to implement the steps of the control method as described above.

Finally, the invention concerns a data processing device comprising means for implementation of the steps of the method as described above.

### BRIEF DESCRIPTION OF THE FIGURES

The invention will be better understood thanks to the following description, which is based on possible embodiments, explained by way of non-limiting illustration, with reference to the appended figures, in which:

FIG. 1 represents schematically an embodiment of the method for controlling a conveying device, comprising a conveyor belt and a control unit;

FIG. 2 represents schematically an embodiment of a conveying facility comprising a conveying device, a lubrication system and a cleaning system.

### DETAILED DESCRIPTION

Hereinafter in the description, elements which have an identical structure or analogous functions will be designated by the same reference.

The invention concerns firstly a method for controlling a conveying device 1.

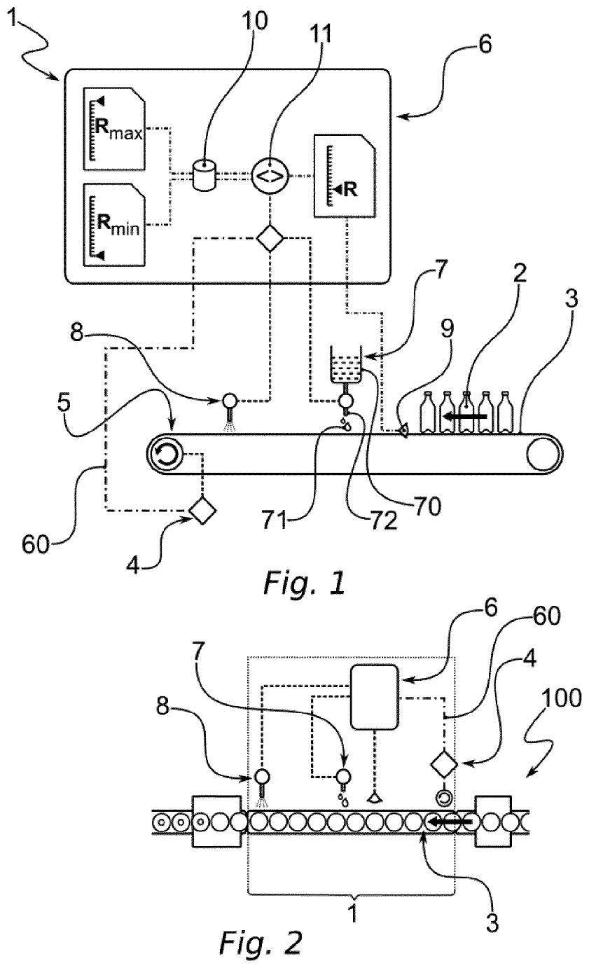

FIG. 1 shows an embodiment of the method for controlling by means of a control unit 6. The conveying device 1 comprises a conveyor belt 3, a drive motor 4 and a control unit 6. The conveying device 1 is designed to transport articles 2 on a transport surface 5 of a conveyor belt 3 by means of a drive motor 4. The articles 2 are for example containers of the bottle or can type, and are displaced by means of the conveyor belt 3 on which they are supported. A container of this type is designed to contain, not exhaustively, a fluid, a liquid, powders or granules, in particular of the foodstuffs or cosmetics type.

Within the packaging line, and as can be seen in FIG. 2, a conveying device 1 conveys articles 2 from an upstream processing station to a downstream processing station, in which they will be subjected to different operations of the type such as filling, labelling, packaging, etc. The transport path between different processing stations can or need not be linear.

The control method according to the invention comprises at least the following steps of:
carrying out a measurement of at least one coefficient of roughness R of the transport surface 5 of the conveyor belt 3;
transmission of said measurement to a control unit 6 of the conveying device 1;
generation of instructions for regulation of the speed in the form of a speed instruction of the conveyor belt 3 by the control unit 6 according to the measurement of the coefficient of roughness R; and
transmission of said instructions to said transport device 1.

The coefficient of roughness R can be measured at different intervals, or it can also be carried out continuously. In particular, this measurement can be carried out by means of one or a plurality of sensors 9, in particular sensors which measure the coefficient of roughness R of the transport surface 5 of the conveyor belt 3, said sensors 9 being able to be situated at different locations of the transport device 1.

Advantageously, the coefficient of roughness R is measured by a sensor, for example via a sensor 9 for measurement of the coefficient of friction.

In some embodiments, the coefficient of roughness R is measured manually, for example via the use of a spring dynamometer.

In other words, the coefficient of roughness R is measured by means of a direct measurement, for example via a sensor 9 for measurement of the coefficient of friction, or by means of an indirect measurement, obtained by a manual measurement.

The coefficient of roughness R is a parameter which can also be estimated, in particular manually. In fact, it depends on different parameters such as the material of the article 2 to be conveyed, and the properties of the conveyor belt 3. Conventional methods are well known by persons skilled in the art for evaluation of the value of this coefficient.

“Measurement of the coefficient of roughness R” thus means a direct measurement, for example via a sensor 9 for measurement of the coefficient of friction, or an indirect measurement, obtained by means of a manual measurement.

In addition, the coefficient of roughness R corresponds to, or depends on, the static coefficient of friction or adherence, hereinafter known as the “COF”. The COF is generally defined as a value according to which two surfaces, often made of different materials, slide against one another. A low COF means low adherence of the articles 3 on the surface of the conveyor belt. A low COF indicates that the transport surfaces are smoother, i.e. they offer less resistance to a sliding movement. In particular, when the COF is too low, the articles 2 to be transported are no longer conveyed at the desired speed, which disrupts the supply by a processing station upstream to the processing stations downstream, and the efficiency of the packaging line. On the other hand, a COF which is too high gives rise to an increased risk of falling of the containers or the articles 2 to be transported.

It is therefore necessary to monitor the value of the COF, and thus the value of the coefficient of roughness of the transport surface 5 of the conveyor belt 3 of a conveying device 1, in order to guarantee optimal transport of the articles 2 and maintain the efficiency of the packaging line. Depending on the direct or indirect measurement of a coefficient of roughness R of the transport surface 5, the control unit 6 will generate instructions for regulation of the speed of the conveyor belt 3.

In particular, the regulation instructions are in the form of a speed instruction.

In some embodiments, the speed instruction is calculated by the control unit after the comparison between the measurement of a coefficient of roughness R of the transport surface 5, and a predetermined optimal value of the coefficient of roughness R.

In other words, a predetermined optimal value corresponds to a permissible value. A permissible value is the value of coefficient of roughness R for which the conveying device 1 operates in an optimal manner, without problems. In this case, the conveyor belt displaces the products at a nominal speed which corresponds to normal operation of the line.

Advantageously, the nominal speed of the conveyor belt 3 is recorded in the control unit 6, in a memory device 10, or in an independent server, either by an operator, or by measurement of the speed, for example by a speed sensor.

According to an additional characteristic, a coefficient of roughness R is measured for one or a plurality of conveying devices 1, and the measurement of the coefficient of roughness R is compared with a predetermined minimal coefficient of roughness Rmin.

According to an additional characteristic, a coefficient of roughness R is measured for one or a plurality of conveying devices 1, and the measurement of the coefficient of roughness R is compared with a predetermined maximal coefficient of roughness Rmax.

In some embodiments, a coefficient of roughness R is measured for one or a plurality of conveying devices 1, and the measurement of the coefficient of roughness R is compared with a predetermined minimal coefficient of roughness Rmin and with a predetermined maximal coefficient of roughness Rmax.

The values of the minimal Rmin and maximal Rmax coefficients of roughness correspond to permissible predetermined values. These values can be recorded by the control unit 6 in a memory device 10, or they can be recorded in an independent server. After this comparison, the control unit 6 will generate instructions for regulation of the speed of the conveyor belt 3. In other words, when the coefficient of roughness R measured of the transport surface 5 is outside a range of predetermined values of coefficients of roughness Rmin, Rmax, the control unit 6 transmits a speed instruction to the conveying device 1. This modification of the initial speed instruction makes it possible to maintain good efficiency of the conveying device 1, and thus of the packaging line. In fact, in the case when the coefficient of roughness diverges from a permissible value or range of values Rmin, Rmax for a category of articles 2, or for a type of downstream processing station, the flow of circulation of said articles 2 is thereby directly affected. The decrease in efficiency of a conveying device 1 can for example lead to a high risk of falling of the articles 2, or also to a considerable slowing down of the conveying flow.

In some embodiments, a plurality of values of minimal Rmin and maximal Rmax coefficients of roughness can be predefined, each of the values being predetermined according to a category of article and/or according to the type of processing to which the articles transported will be subjected at a downstream processing station.

A category of articles 2 is defined in particular by the nature of the articles 2, for example containers of the type such as vial, bottle, can, carton, cardboard boxes. It can also be defined according to the material of the articles 2 (glass, PET, cardboard) or also their form or weight. For example, the first category of articles 2 relating to plastic bottles, values of minimal Rmin and maximal Rmax coefficient of roughness are predefined. For a second category of articles 2 relating to cans, other values of minimal Rmin and maximal Rmax coefficient of roughness are predefined.

All of these values can be recorded directly in the control unit 6 in a memory device 10, or recorded in an independent server.

The downstream processing units can in particular be a blowing station, a filling station, a packaging station, or any other type of station present on a packaging line.

In some embodiments, speed instructions are associated with values of coefficient of roughness R. Preferably, the associated speed instructions are stored by the control unit 6 in a memory device 10 or in an independent server. For example, speed instructions corresponding to the nominal speed of the conveyor belt 3 are associated with values of coefficient of roughness R contained between the minimal Rmin and maximal Rmax values of coefficient of roughness. Advantageously, the control unit comprises a man-machine interface. An operator of the packaging line can for example acquire via the control unit 6 different instructions, or also information relating to the packaging line, such as the nominal speed of the conveyor belt 3, the category of articles 2 to be processed, etc.

For example, the values of the minimal Rmin and maximal Rmax coefficients of roughness are acquired via said man-machine interface of the control unit 6 by an operator of the packaging line comprising one or a plurality of conveying devices 1.

According to a possible additional characteristic, the control unit 6 generates speed instructions in the form of a speed instruction, the speed instruction being defined according to a coefficient of proportionality applied to the coefficient of roughness R measured. A coefficient of proportionality of this type is predetermined, and can be recorded in the memory device 10 of the control unit 6.

Advantageously, the control unit 6 applies different coefficients of proportionality to the coefficient of roughness R measured, according to different ranges of values of coefficient of proportionality. These different ranges of permissible values for the values of coefficient of proportionality can be defined for a single category of articles 2, for different categories of articles 2, or also for different downstream processing stations.

In some embodiments, in cases where the coefficient of roughness R measured is in a permissible range of values, the control unit 6 does not generate speed regulation instructions in the form of a speed instruction.

According to an possible additional characteristic, in the case when the coefficient of roughness R measured is in a range of permissible values, the control unit 6 generates speed instructions in the form of a speed instruction, with the speed instruction corresponding to the nominal speed of the conveyor belt 3, in normal conditions of the packaging line.

In some embodiments, the control unit 6 generates speed regulation instructions, in the form of an instruction for reduction of the speed of the conveyor belt 3, when the coefficient of roughness R measured is greater than the predetermined maximal coefficient of roughness Rmax. In fact, in this configuration, and until the normal value of the coefficient of roughness R measured returns, it is advantageous to reduce the speed of the conveyor belt 3, since the articles 2 are more subject to risks of falling or tilting.

In some embodiments, the control unit 6 generates speed regulation instructions, in the form of an instruction for increase of the speed of the conveyor belt 3 when the coefficient of roughness R measured is lower than the predetermined minimal coefficient of roughness Rmin. In fact, in this configuration, the sliding between the articles 2 transported and the transport surface 5 is too great, and the articles 2 no longer advance, or advance only at a very low speed, with this speed no longer corresponding to the speed parameterized for the conveyor belt 3, which slows down the conveying flow of said articles 2, and it is then advantageous to transmit to the conveying device 1 an instruction for acceleration of the conveyor belt 3, in order to maintain the efficiency of the conveying device 1, and thus of the packaging line.

According to an additional characteristic, the control unit 6 records the values measured for the coefficient of roughness R and the regulation instructions transmitted to the conveying device 1 for conveying in a memory device 10 after the measurement has been carried out. By this means, when a new measurement of the coefficient of roughness R shows that there is a new divergence, i.e. a difference between the preceding measurement and the new measurement carried out, the control unit 6 transmits speed regulation instructions to the conveying device 1, with an updated speed instruction. In the case when the new measurement of the coefficient of roughness R carried out corresponds to the preceding measurement, the control unit 6 does not provide new speed regulation instructions in the form of a speed instruction to the conveying device 1.

In some embodiments, the method for controlling the conveying device 1 comprises an additional step of lubrication of the transport surface 5 of the conveyor belt 3. This additional step is carried out by at least one lubrication system 7, shown in FIG. 1 and in FIG. 2. The control unit 6 is connected to said at least one lubrication system 7, and generates lubrication instructions in the form of a lubrication instruction on the basis of the measurement of the coefficient of roughness R. Said control unit 6 can be connected by means of wired or wireless technology, or also by a dedicated communications channel.

The lubrication instructions are generally in the form of programming of a lubrication cycle, which defines the frequency of lubrication, the quantity of lubricant 71 to be deposited on the transport surface 5 of the conveyor belt 3, and the duration of the cycles, etc. The control unit 6 can for example provide a lubrication instruction which is intended to modify the dose of lubricant 71 to be deposited by an applicator 72, by transmitting to said lubrication system 7 an instruction indicating modification of the times of opening and/or closure of the valve of the source 7 of lubricant 71. The control method can be applied to all the known lubrication systems 7, and in particular lubrication systems of the dry, liquid, gas or mixed type. The applicator 72 can be in the form of a nozzle, a brush, or in the form of any type of known applicator 72 for lubricant 71. Thus, via the measurement of the coefficient of roughness R, the control unit 6 will generate lubrication instructions, making it possible to adapt the lubrication cycle to the requirements of the packaging line, in order to maintain a high level of efficiency.

Advantageously, the step of generation of lubrication instructions comprises an additional, prior step of comparison of the measurement of the coefficient of roughness R with a predetermined minimal coefficient of roughness Rmin and/or with a predetermined maximal coefficient of roughness Rmax. The control unit 6 then generates lubrication regulation instructions, if the difference between the measurement of the coefficient of roughness R and the value of the minimal coefficient of roughness Rmin and/or the value of the maximal coefficient of roughness Rmax is greater than a determined threshold.

The generation of lubrication instructions by the control unit 6 can also be derived from a first comparison of the measurement of the coefficient of roughness R with a predetermined minimal coefficient of roughness Rmin and/or a predetermined maximal coefficient of roughness Rmax for the generation of instructions for regulation of the speed. In this case, the control unit 6 generates instructions which are based on said comparison, with the instructions being instructions for regulation of speed and instructions for lubrication.

According to an additional characteristic, the values of minimal Rmin and maximal Rmax permissible coefficient of roughness depend on the category of articles 2, and/or on the type of downstream processing which said articles 2 will undergo.

Advantageously, the permissible difference in comparison with the predetermined values Rmin and Rmax can be defined according to the category of articles 2, and/or the type of processing station situated downstream.

The fact of being able to generate lubrication instructions according to the coefficient of roughness R measured permits return to normal of the speed of the conveying device 1. In fact, the step of regulation of the speed is necessary and extremely advantageous, since it makes it possible to respond without waiting for an identified problem of measurement of the coefficient of roughness R. However, it continues to be necessary to deal with the problem, and ensure that the coefficient of roughness R returns to a permissible range of values Rmin, Rmax.

Thus, advantageously, the lubrication instructions which are transmitted by the control unit 6 can make it possible to regain a measurement of permissible coefficient of roughness R. In this case, i.e. when the coefficient of roughness R measured is in a permissible range of values, the control unit 6 transmits new regulation instructions in the form of a speed instruction, said speed instruction corresponding to the nominal conveying speed, i.e. to the initial value of the conveying speed of the conveyor belt 3. By this means, the conveying device 1 is operating normally. The efficiency of the conveying device 1, and thus of the packaging line, is therefore maintained, and remains satisfactory.

In some embodiments, the method for controlling a conveying device 1 comprises an additional step of cleaning of the conveyor belt 5 by a cleaning system 8, with the control unit 6 being connected to said system 8 for cleaning of said conveyor belt 6.

Said control unit 6 can be connected to the cleaning system 8 by means of wired or wireless technology, or also by a dedicated communication channel.

The control unit 6 generates cleaning instructions in the form of a cleaning instruction according to the measurement of the coefficient of roughness R. On a conveying device 1, a cleaning cycle is in general planned outside the hours of operation of the packaging line. Nevertheless, it may happen that the cleaning step must be carried out in advance, since the operation of the packaging line is strongly affected thereby.

Advantageously, the control unit 6 will generate cleaning instructions according to the measurement of the coefficient of roughness R, and will transmit the instructions to the cleaning system 8. This can be the case in particular when, despite actions of regulation of lubrication for the purpose of improving the coefficient of roughness R, this coefficient remains outside the ranges of permissible values.

Advantageously, and in particular in this case, but not only then, the control unit 6 can decide to transmit instructions for regulation of the speed to the conveying device 1, in order to maintain the efficiency of the line and/or transmit cleaning instructions. The cleaning instructions can for example be in the form of advance programming of cleaning of the transport surface 5 of the conveyor belt 3, or also modification of the cleaning program to be carried out. “Cleaning” means rinsing or cleaning with the use of a cleaning product.

Advantageously, the step of generation of cleaning instructions comprises an additional, prior step, of comparison of the measurement of the coefficient of roughness R with a predetermined minimal coefficient of roughness Rmin and/or a predetermined maximal coefficient of roughness Rmax. The control unit 6 then generates cleaning instructions, if the difference between the measurement of the coefficient of roughness R and the value of the minimal coefficient of roughness Rmin and/or the value of the maximal coefficient of roughness Rmax is greater than a determined threshold.

The generation of lubrication instructions by the control unit 6 can also be derived from a first comparison of the measurement of the coefficient of roughness R with a predetermined minimal coefficient of roughness Rmin and/or with a predetermined maximal coefficient of roughness Rmax for the generation of instructions for regulation of the speed. In this case, the control unit 6 generates instructions based on said comparison, with the instructions being instructions for regulation of the speed and cleaning instructions.

Advantageously, on the basis of a comparison of the measurement of the coefficient of roughness R with a predetermined minimal coefficient of roughness Rmin and/or with a predetermined maximal coefficient of roughness Rmax, the control unit 6 then generates different instructions if the difference between the measurement of the coefficient of roughness R and the value of the minimal coefficient of roughness Rmin and/or the value of the maximal coefficient of roughness Rmax is greater than a determined threshold, the instructions being speed regulation instructions, lubrication instructions, and cleaning instructions. It is understood that these different instructions can be transmitted simultaneously or sequentially to the conveying device 1. Preferably, the instructions for regulation of the conveying speed are transmitted first.

According to an additional characteristic, the values of minimal Rmin and maximal Rmax permissible coefficient of roughness depend on the category of articles 2, and/or on the type of downstream processing to which said articles 2 will be subjected.

Advantageously, the permissible difference between the predetermined values Rmin and Rmax can be defined according to the category of articles 2 and the type of processing station situated downstream.

According to a possible additional characteristic, one or a plurality of steps of the method for controlling the transport device 1 is implemented by computer.

The invention also concerns a conveying facility 100 as shown in FIG. 2. The facility 100 comprises a conveying device 1 which is designed to transport articles 2. As previously stated, the device 1 comprises a conveyor belt 3 provided with a transport surface 5, a drive motor 4 and a control unit 6.

The facility 100 also comprises one or a plurality of sensors 9 in order to measure the coefficient of roughness R, for example in the form of at least one sensor 9 for measurement of the coefficient of friction.

The facility 100 is characterized in that the control unit 6 generates speed regulation instructions in the form of a speed instruction of the conveyor belt 3 according to the measurement of a coefficient of roughness R by a sensor 9, said control unit 6 comprising a communication channel 60, in order to transmit said instructions to the conveying device 1.

The communication channel 60 can be wired or wireless. The control unit 6 can also be connected to an independent server.

According to a possible additional characteristic, the control unit 6 comprises a memory device 10 in which there are stored predetermined values of the minimal and maximal coefficients of roughness Rmin, Rmax, and a comparison device 11 in order to compare a coefficient of roughness R measured by a sensor 9 with the values of the coefficients of roughness Rmin, Rmax.

In particular, different values of permissible coefficient of roughness Rmin, Rmax are stored, either in a memory device 10, or in an independent server, according to the category of articles 2 which are transported by the conveying device 1, or also according to the type of processing station situated downstream.

In some embodiments, the conveying facility comprises at least one system 7 for lubrication of the transport surface 5 of the conveyor belt 3. A lubrication system 7 comprises a source 70 of lubricant 71, and receives lubrication instructions from the control unit 6 in the form of a lubrication instruction, on the basis of measurement of a coefficient of roughness R by a sensor 9.

In some embodiments, the facility comprises a system 8 for cleaning of the transport surface 5 of the conveyor belt 3. The control method can be applied to all the known cleaning systems 8. Preferably, the cleaning system 8 comprises at least one nozzle connected to a main channel, a distribution unit or tank to supply said at least one nozzle with at least one cleaning liquid and/or rinsing liquid, said at least one nozzle being designed to direct the cleaning liquid and/or the rinsing liquid to a part of the transport surface 5 of the conveyor belt 3. In addition, the cleaning system 8 receives instructions from the control unit 6 in the form of a cleaning instruction, on the basis of the measurement of a coefficient of roughness R by a sensor 9.

FIG. 2 shows an embodiment where the conveying facility comprises a lubrication system 7 and a cleaning system 8.

The invention also concerns a computer program product comprising a sequence of instructions which, when the program is executed by a computer, leads the computer to implement the steps of the method for controlling a conveying device 1 as described above.

The invention also concerns a data processing device comprising means for implementation of the steps of the control method as described above.

Finally, the invention concerns a recording support which can be read by a computer comprising instructions which, when they are executed by a computer, lead the computer to implement the steps of the method for controlling a conveying device 1 as described above.

The method for controlling a conveying device 1 according to the invention makes it possible to regulate the transport speed of a device 1 of this type when the friction conditions of the articles 2 to be conveyed are not optimal, which advantageously makes it possible to maintain great efficiency of the conveying device 1, and on a larger scale of the packaging line as a whole. In particular, the control method makes it possible to compensate for the fact that, if the coefficient of roughness is too high, the articles 2 do not advance at the prescribed speed, and that it is necessary to transmit a new speed instruction to the conveying device 1 in order to obtain the same flow of transport of articles 2.

Although the above description is based on particular embodiments, it in no way limits the scope of the invention, and modifications can be made, in particular by substitution of technical equivalents or by different combination of some or all of the characteristics described above.

1. A method for controlling a conveying device for transporting articles, said conveying device comprising a conveyor belt provided with a transport surface, a drive motor and a control unit, wherein the method comprises at least the following steps of:
carrying out a measurement of a coefficient of roughness of the transport surface;
transmission of said measurement to said control unit;
generation of instructions for regulation of the speed of the conveyor belt in the form of a speed instruction by the control unit, according to the coefficient of roughness measured; and
transmission of said instructions to said conveying device.

2. The method for controlling as claimed in claim 1, wherein the generation of instructions comprises an additional sub-step of:
comparison of the measurement of the coefficient of roughness with one or both of a predetermined minimal coefficient of roughness (Rmin), and a predetermined maximal coefficient of roughness (Rmax); and
wherein the control unit generates instructions for regulation of the speed if a difference between the measurement of the coefficient of roughness and the value of one or both of the Rmin and the Rmax is greater than a determined threshold.

3. The method for controlling as claimed in claim 1, wherein the control unit generates a speed instruction defined according to a coefficient of proportionality applied to the measurement of the coefficient of roughness.

4. The method for controlling as claimed in claim 1, wherein the control unit generates instructions in the form of an instruction for the reduction of the speed of the conveyor belt when the measurement of the coefficient of roughness is greater than a predetermined maximal coefficient of roughness (Rmax).

5. The method for controlling as claimed in claim 1, wherein the control unit generates instructions in the form of an instruction for increase of the speed of the conveyor belt when the measurement of the coefficient of roughness is lower than a predetermined minimal coefficient of roughness (Rmin).

6. The method for controlling as claimed in claim 1, further comprising an additional step of lubrication of the transport surface of the conveyor belt by at least one lubrication system, the control unit being connected to said at least one lubrication system, and generating lubrication instructions in the form of a lubrication instruction on the basis of the measurement of the coefficient of roughness.

7. The method for controlling as claimed in claim 6, wherein the step of generation of lubrication instructions comprises an additional sub-step of:
comparison of the measurement of the coefficient of roughness with one or both of a predetermined minimal coefficient of roughness (Rmin) and a predetermined maximal coefficient of roughness (Rmax), and wherein the control unit generates lubrication instructions if the difference between the measurement of the coefficient of roughness and a value of one or both of Rmin and Rmax is greater than a determined threshold.

8. The method for controlling as claimed in claim 1, comprising an additional step of cleaning of the transport surface of the conveyor belt by a cleaning system, with the control unit being connected to said cleaning system, and generating cleaning instructions in the form of a cleaning instruction according to the coefficient of roughness measured.

9. The method for controlling as claimed in claim 8, wherein the step of generation of cleaning instructions comprises an additional sub-step of comparison of the measurement of the coefficient of roughness with one or both of a predetermined minimal coefficient of roughness (Rmin) and a predetermined maximal coefficient of roughness (Rmax), and wherein the control unit generates cleaning instructions if a difference between the measurement of the coefficient of roughness and one or both of a value of a minimal coefficient of roughness (Rmin) and a value of a maximal coefficient of roughness (Rmax) is greater than a determined threshold.

10. A conveying facility comprising:
a conveying device which is designed to transport articles, said device comprising a conveyor belt provided with a transport surface, a drive motor and a control unit; and
at least one sensor;
wherein the control unit generates instructions for regulation of a speed said conveyor belt, the instructions in the form of a speed instruction according to the measurement of a coefficient of roughness by at least said sensor, said control unit comprising a communication channel to transmit said instructions to said conveying device.

11. The conveying facility claimed in claim 10, wherein the control unit comprises:
a memory device in which there are recorded predetermined values of a minimal and a maximal coefficient of roughness (Rmin, Rmax); and
a comparison device configured to compare a coefficient of roughness measured by a sensor with the values of the (Rmin and the Rmax recorded.

12. The facility as claimed in claim 10, comprising at least one system for lubrication of the transport surface of the conveyor belt, with said at least one lubrication system comprising a source of lubricant and an applicator for said lubricant, and in that wherein the at least one lubrication system is configured to receive lubrication instructions from the control unit in the form of a lubrication instruction on a basis of the measurement of the coefficient of roughness by a sensor.

13. The facility as claimed claim 10 , further comprising a system for cleaning of the transport surface of the conveyor belt, said cleaning system configured to receive instructions from the control unit in the form of a cleaning instruction on the basis of the measurement of the coefficient of roughness by a sensor.

14. A computer-readable storage medium comprising a sequence of instructions which, when the program is executed by a computer, causes the computer to implement steps of a method, wherein the method comprises:
carrying out a measurement of a coefficient of roughness of a transport surface of a conveying device, a drive motor and a control unit, wherein the conveying device comprises a conveyor belt provided with the transport surface;
transmission of said measurement to said control unit; and
generation of instructions for regulation of the speed of the conveyor belt in the form of a speed instruction by the control unit, according to the coefficient of roughness measured; and
transmission of said instructions to said conveying device.

15. A data processing device configured to implement the steps of the method as claimed in claim 1.
